(19) United States
(12) Patent Application Publication
(10) Pub. No.: US 2011/0071835 A1
(43) Pub. Date: Mar. 24, 2011

(54) SMALL FOOTPRINT TEXT-TO-SPEECH ENGINE

(75) Inventors: Yi-Ning Chen, Beijing (CN); Zhi-Jie Yan, Beijing (CN); Frank Kao-Ping Soong, Beijing (CN)

(73) Assignee: MICROSOFT CORPORATION, Redmond, WA (US)

(21) Appl. No.: 12/564,326

(22) Filed: Sep. 22, 2009

(51) Int. Cl. G10L 13/08; G10L 15/14

(52) U.S. Cl. 704/260; 704/E13.011; 704/256.2

(57) ABSTRACT

Embodiments of small footprint text-to-speech engine are disclosed. In operation, the small footprint text-to-speech engine generates a set of feature parameters for an input text. The set of feature parameters includes static feature parameters and delta feature parameters. The small footprint text-to-speech engine then derives a saw-tooth stochastic trajectory that represents the speech characteristics of the input text based on the static feature parameters and the delta parameters. Finally, the small footprint text-to-speech engine produces a smoothed trajectory from the saw-tooth stochastic trajectory, and generates synthesized speech based on the smoothed trajectory.

### BACKGROUND

A text-to-speech engine is a software program that generates speech from inputted text. A text-to-speech engine may be useful in applications that use synthesized speech, such as a wireless communication device that reads incoming text messages, a global positioning system (GPS) that provides voice directional guidance, or other portable electronic devices that present information as audio speech. As a result, text-to-speech engines are often used in embedded systems that have limited memory and processing power.

In prior implementations of a typical text-to-speech engine, the text-to-speech engine may generate a set of feature parameters from an input text, whereby the set of feature parameters may include static feature parameters, delta feature parameters, and acceleration feature parameters. The typical text-to-speech engine may then generate synthesized speech by processing the set of feature parameters with stream dependent Hidden Markov Models (HMMs).

### SUMMARY

Described herein are techniques and systems for providing a Hidden Markov Model (HMM)-based text-to-speech engine that has a small footprint and exhibits small latency when compared to traditional text-to-speech engines.

The small footprint of the text-to-speech engine, in accordance with the embodiments described herein, may enable the text-to-speech engine to be embedded in devices with limited memory and processing power capabilities. Moreover, the short latency of the text-to-speech engine in accordance with the embodiments may result in a more pleasant and responsive experience for users.

In at least one embodiment, the small footprint text-to-speech engine generates a set of feature parameters for an input text. The set of feature parameters includes static feature parameters and delta feature parameters. The small footprint text-to-speech engine then derives a saw-tooth stochastic trajectory that represents the speech characteristics of the input text based on the static feature parameters and the delta parameters. Finally, the small footprint text-to-speech engine produces a smoothed trajectory from the saw-tooth stochastic trajectory, and generates synthesized speech based on the smoothed trajectory. Other embodiments will become more apparent from the following detailed description when taken in conjunction with the accompanying drawings.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a block diagram that illustrates an example scheme that implements the small footprint text-to-speech engine, in accordance with various embodiments thereof.

FIG. 2 is a block diagram that illustrates selected components of the small footprint text-to-speech engine, in accordance with various embodiments.

FIGS. 3a and 3b are example graphs that illustrate the post generation smoothing of audio trajectories, in accordance with various embodiments.

FIG. 4 is a flow diagram that illustrates an example process to generate synthesized speech from input text via the small footprint text-to-speech engine, in accordance with various embodiments.

FIG. 5 is a flow diagram that illustrates an example process to optimize the generation of feature parameters using the small footprint text-to-speech engine, in accordance with various embodiments.

FIG. 6 is a block diagram that illustrates a representative computing device that may implement the small footprint text-to-speech engine.

### DETAILED DESCRIPTION

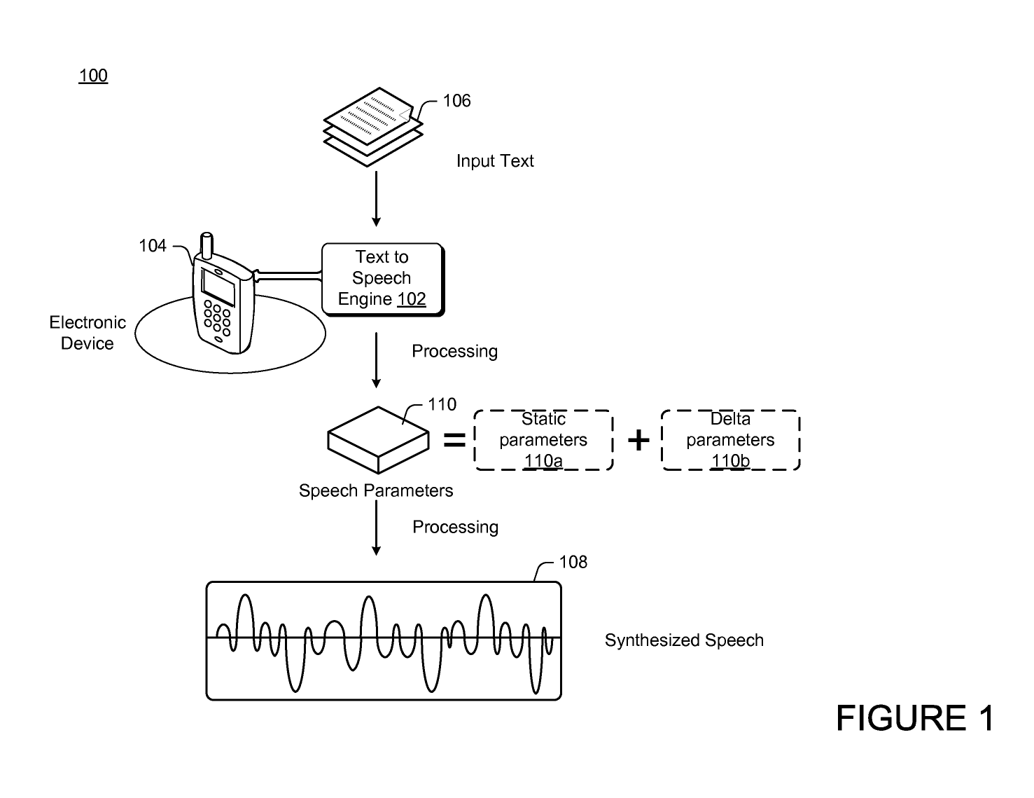

The embodiments described herein pertain to a Hidden Markov Model (HMM)-based text-to-speech engine that has a small footprint and exhibits small latency when compared to traditional text-to-speech engines. In various embodiments, the small footprint text-to-speech engine may be especially suitable for use in embedded systems that have limited memory and processing capability. Accordingly, the small footprint text-to-speech engine may provide greater features and better user experience in comparison to other text-to-speech engines. As a result, user satisfaction with the embedded systems that present information via synthesized speech may be increased at a minimal cost. Various examples for the small footprint text-to-speech engine in accordance with the embodiments are described below with reference to FIGS. 1-6.

### Example Scheme

FIG. 1 is a block diagram that illustrates an example scheme that implements the small footprint text-to-speech engine 102, in accordance with various embodiments.

The text-to-speech engine 102 may be implemented on an electronic device 104. The electronic device 104 may be a portable electronic device that includes one or more processors that provide processing capabilities and a memory that provides data storage/retrieval capabilities. In various embodiments, the electronic device 104 may be an embedded system, such as a smart phone, a personal digital assistant (PDA), a digital camera, a global position system (GPS) tracking unit, or the like. However, in other embodiments, the electronic device 104 may be a general purpose computer, such as a desktop computer, a laptop computer, a server, or the like. Further, the electronic device 104 may have network capabilities. For example, the electronic device 104 may exchange data with other electronic devices (e.g., laptops computers, servers, etc.) via one or more networks, such as the Internet.

The text-to-speech engine 102 may convert the input text 106 into synthesized speech 108. The input text 106 may be inputted into the text-to-speech engine 102 as electronic data (e.g., ACSCII data). In turn, the text-to-speech engine 102 may output synthesized speech 108 in the form of an audio signal. In various embodiments, the audio signal may be electronically stored in the electronic device 104 for subsequent retrieval and/or playback. The outputted synthesized speech 108 (i.e., audio signal) may be further transformed by electronic device 104 into an acoustic form via one or more speakers.

During the conversion of input text 106 into synthesized speech 108, the text-to-speech engine 102 may derive speech parameters 110. The speech parameters 110 may include static feature parameters 110a and delta feature parameters 110b. The text-to-speech engine 102 may derive a stochastic trajectory that represents the speech characteristics of the input text 106 based on the static feature parameters 110a and the delta feature parameters 110b. Due to such an implementation of the stochastic trajectory derivation, the amount of the calculations performed by the text-to-speech engine 102 during the conversion of input text 106 to synthesized speech 108 may be reduced to approximately 50% of the calculations performed by a typical text-to-speech engine.

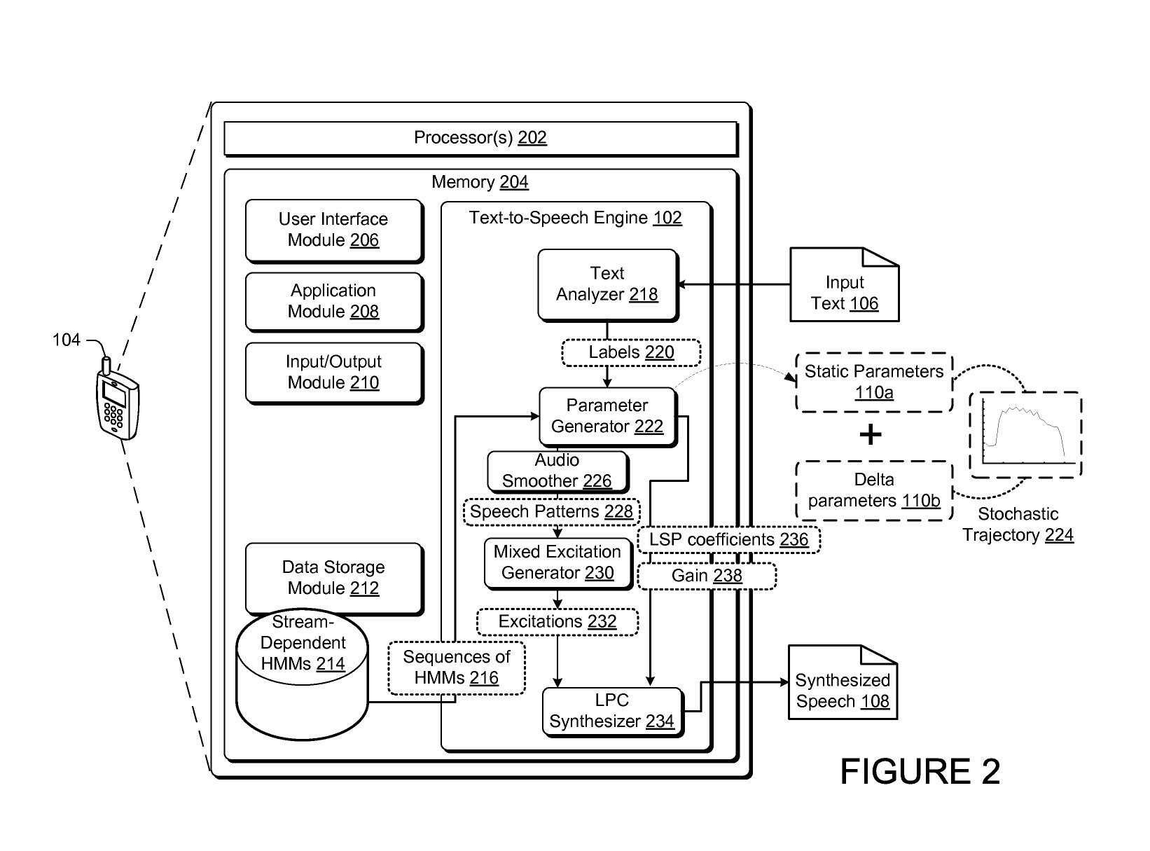

Accordingly, the processing capacity used by the text-to-speech engine 102 during the conversion may be correspondingly reduced. In turn, this reduction may also diminish the amount of latency associated with the conversion of the input text 106 to synthesized speech 108, and/or free up processing and memory resource for use by other application. However, in order to compensate for certain anomalies introduced by the generation of the stochastic trajectory based on the static feature parameters 110a and delta feature parameters 110b, the text-to-speech engine 102 may perform further processing that includes audio smoothing prior to outputting the synthesized speech 108. This further additional processing is described with respect to FIG. 2.

FIG. 2 is a block diagram that illustrates selected components of the small footprint text-to-speech engine 102, in accordance with various embodiments. The selected components may be implemented on an electronic device 104 (FIG. 1). The client device 104 may include one or more processors 202 and memory 204. For example, but not as a limitation, the one or more processors 202 may include a reduced instruction set computer (RISC) processor.

The memory 204 may include volatile and/or nonvolatile memory, removable and/or non-removable media implemented in any method or technology for storage of information, such as computer-readable instructions, data structures, program modules or other data. Such memory may include, but is not limited to, random accessory memory (RAM), read-only memory (ROM), electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and is accessible by a computer system. Further, the components may be in the form of routines, programs, objects, and data structures that cause the performance of particular tasks or implement particular abstract data types.

The memory 204 may store components. The components, or modules, may include routines, programs instructions, objects, and/or data structures that perform particular tasks or implement particular abstract data types. The selected components include a text-to-speech engine 102, a user interface module 206, an application module 208, the input/output module 210, and a data storage module 212.

The data storage module 212 may be configured to store data in a portion of memory 204 (e.g., a database). The data storage module 212 may store stream-dependent Hidden Markov Models (HMMs) 214. A hidden Markov model (HMM) is a finite state machine which generates a sequence of discrete time observations.

In various embodiments, the stream-dependent HMMs 214 may be trained to model speech data. For example, the HMMs 214 may be trained via, e.g., a broadcast news style North American English speech sample corpus for the generation of American-accented English speech. In other examples, the HMMs 214 may be similarly trained to generated speech in other languages (e.g., Chinese, Japanese, French, etc.) Accordingly, the text-to-speech engine 102 may retrieve one or more sequences of HMMs 216 from the data storage module 212 during the conversion of input text 106 to synthesized speech 108.

### Use of Speech Feature Parameters

In various embodiments, the text-to-speech engine 102 may include a text analyzer 218 that transforms input text 106 into context-dependent phoneme labels 220. The context dependent phoneme labels 220 may be further inputted into the parameter generator 222. At the parameter generator 222, the context-dependent phoneme labels 220 may be parameterized by the generation of feature parameters 110 based on the sequences of HMMs 214. The generated feature parameters 110 may include static feature parameters 110a and delta feature parameters 110b.

In a typical text-to-speech engine, the parameterization of the phoneme labels (e.g., phoneme labels 220) may include the generation of a log-gain stochastic trajectory 224 via the Maximum Likelihood (ML) criterion. The generation of the stochastic trajectory 224 may be expressed as follows:

W′U⁻¹WC=W′U⁻¹WM (1)

in which U=diag[U_{q}_{₁}, . . . , U_{q}_{_{T}}] and M=[M_{q}_{₁}′, . . . , M_{q}_{_{T}}′]′ are variance and mean matrices of a state sequence Q, as obtained from the HMMs 214. Further, qᵢ may represent the index of the state at frame i, W may be composed by calculating the weights of the dynamic feature parameters, and C may present the generated trajectory.

Accordingly, equation (1) may also be written as

AC=b (2)

in which A=W′U⁻¹W, and b=W′U⁻¹WM.

In turn, A=W′U⁻¹W may be further expressed as:

W_{static}^{T}U_{static}⁻¹W_{static}+W_{delta}^{T}U_{delta}⁻¹W_{delta}+W_{acc}^{T}U_{acc}⁻¹W_{acc} (3)

and b=W′U⁻¹WM may be further expressed as:

W_{static}^{T}U_{static}⁻¹M_{static}+W_{delta}^{T}U_{delta}⁻¹M_{delta}+W_{acc}^{T}U_{acc}⁻¹M_{acc} (4)

In which W_{static}^{T}U_{static}⁻¹W_{static} and W_{static}^{T}U_{static}⁻¹M_{static} may represent the static feature parameters (e.g., static feature parameters 110a), W_{delta}^{T}U_{delta}⁻¹W_{delta} and W_{delta}^{T}U_{delta}⁻¹M_{delta} may represent the delta feature parameters (e.g., delta feature parameters 110b), and W_{acc}^{T}U_{acc}⁻¹W_{acc} and W_{acc}^{T}U_{acc}⁻¹M_{acc} may represent acceleration feature parameters.

Moreover, the delta and acceleration feature parameters may be linear combinations of the static feature parameters as

$${Δ}^{( n )} {c}_{t} = {\sum }_{i = - {L}^{( n )}}^{{L}^{( n )}} {w}_{i}^{( n )} {c}_{t + i} , n = 0 , 1 , 2.$$

For example, the standard weights for HMM-based text-to-speech conversion may be:

{w₋₁⁽⁰⁾, w₀⁽⁰⁾, w₁⁽⁰⁾}={0, 1, 0} static (5)

{w₋₁⁽¹⁾, w₀⁽¹⁾, w₁⁽¹⁾}={−0.5, 0, 0.5} delta (6)

{w₋₁⁽²⁾, w₀⁽²⁾, w₁⁽²⁾}={−1, 2, −1} acceleration (7)

Thus, when the window weights are set as equations (5)-(7), a symmetric matrix A referred to in equation (2) may be a matrix with 5 diagonals. The matrix may possess nonzero elements only in the main diagonal, the first and second diagonals below and above the main diagonal, as shown below:

$${A}_{with\_acc} = ( \begin{matrix}{a}_{1 , 1} & {a}_{1 , 2} & {a}_{1 , 3} & 0 & 0 \\ {a}_{1 , 2} & {a}_{2 , 2} & {a}_{2 , 3} & {a}_{2 , 4} & 0 \\ {a}_{1 , 3} & {a}_{2 , 3} & {a}_{3 , 3} & {a}_{3 , 4} & {a}_{3 , 5} \\ 0 & {a}_{2 , 4} & {a}_{3 , 4} & {a}_{4 , 4} & {a}_{4 , 5} \\ 0 & 0 & {a}_{3 , 5} & {a}_{4 , 5} & {a}_{5 , 5}\end{matrix} ) \qquad ( 8 )$$

However, since the text-to-speech engine 102 may generate a stochastic trajectory 224 based on the static feature parameters 110a and delta feature parameters 110b, the structure of matrix A may be changed. In at least one embodiment, the matrix A may have nonzero elements only in the main diagonal and the second diagonals below and above the main diagonal, as shown below:

$${A}_{without\_acc} = ( \begin{matrix}{a}_{1 , 1} & 0 & {a}_{1 , 3} & 0 & 0 \\ 0 & {a}_{2 , 2} & 0 & {a}_{2 , 4} & 0 \\ {a}_{1 , 3} & 0 & {a}_{3 , 3} & 0 & {a}_{3 , 5} \\ 0 & {a}_{2 , 4} & 0 & {a}_{4 , 4} & 0 \\ 0 & 0 & {a}_{3 , 5} & 0 & {a}_{5 , 5}\end{matrix} ) \qquad ( 9 )$$

Accordingly, even numbered elements and odd numbered elements in the equation (9) may be separable. Therefore, equation (10), which may be used to calculate the stochastic trajectory 224, can be rewritten as two equivalent sets of equations (11) and (12).

$$\begin{matrix}( \begin{matrix}{a}_{1 , 1} & 0 & {a}_{1 , 3} & 0 & 0 \\ 0 & {a}_{2 , 2} & 0 & {a}_{2 , 4} & 0 \\ {a}_{1 , 3} & 0 & {a}_{3 , 3} & 0 & {a}_{3 , 5} \\ 0 & {a}_{2 , 4} & 0 & {a}_{4 , 4} & 0 \\ 0 & 0 & {a}_{3 , 5} & 0 & {a}_{5 , 5}\end{matrix} ) [ \begin{matrix}{c}_{1} \\ {c}_{2} \\ {c}_{3} \\ {c}_{4} \\ {c}_{5}\end{matrix} ] = [ \begin{matrix}{b}_{1} \\ {b}_{2} \\ {b}_{3} \\ {b}_{4} \\ {b}_{5}\end{matrix} ] & ( 10 ) \\ ( \begin{matrix}{a}_{1 , 1} & {a}_{1 , 3} & 0 \\ {a}_{1 , 3} & {a}_{3 , 3} & {a}_{3 , 5} \\ 0 & {a}_{3 , 5} & {a}_{5 , 5}\end{matrix} ) [ \begin{matrix}{c}_{1} \\ {c}_{3} \\ {c}_{5}\end{matrix} ] = [ \begin{matrix}{b}_{1} \\ {b}_{3} \\ {b}_{5}\end{matrix} ] & ( 11 ) \\ ( \begin{matrix}{a}_{2 , 2} & {a}_{2 , 4} \\ {a}_{2 , 4} & {a}_{4 , 4}\end{matrix} ) [ \begin{matrix}{c}_{2} \\ {c}_{4}\end{matrix} ] = [ \begin{matrix}{b}_{2} \\ {b}_{4}\end{matrix} ] & ( 12 )\end{matrix}$$

Using Square Root version of Cholesky Decomposition

The parameter generator 222 may further use a square root version of Cholesky decomposition to solve equation (10) and derive the stochastic trajectory 224. The Cholesky decomposition is a decomposition of a symmetric, positive-definite matrix into the product of a lower triangular matrix and its conjugate transpose. The square root version of the Cholesky decomposition may be expressed as follows:

$$\begin{matrix}\begin{matrix}A = {LL}^{T} \\ = ( \begin{matrix}{L}_{11} & 0 & 0 \\ {L}_{21} & {L}_{22} & 0 \\ {L}_{31} & {L}_{32} & {L}_{33}\end{matrix} ) ( \begin{matrix}{L}_{11} & {L}_{21} & {L}_{31} \\ 0 & {L}_{22} & {L}_{32} \\ 0 & 0 & {L}_{33}\end{matrix} ) \\ = ( \begin{matrix}{L}_{11}^{2} & & ( symmetrical ) \\ {L}_{21} {L}_{11} & {L}_{21}^{2} + {L}_{22}^{2} & \\ {L}_{31} {L}_{11} & {L}_{31} {L}_{21} + {L}_{32} {L}_{22} & {L}_{31}^{2} + {L}_{32}^{2} + {L}_{33}^{2}\end{matrix} )\end{matrix} & ( 13 ) \\ {L}_{i , i} = \sqrt{{A}_{i , i} - {\sum }_{k = 1}^{i - 1} {L}_{i , k}^{2}} & ( 14 ) \\ {L}_{i , j} = \frac{1}{{L}_{i , j}} ( {A}_{i , j} - {\sum }_{k = 1}^{j - 1} {L}_{i , k} {L}_{j , k} ) , for i > j & ( 15 )\end{matrix}$$

Thus, in order to solve the equation (10), the parameter generator 222 may derive the solution in two logical steps. Initially, the parameter generator 222 may solve equation (10) for Ly=b for y. Subsequently, the parameter generator 222 may solve the equation (10) for L^{T}x=y for x.

Moreover, the parameter generator 222 may also take the band matrix of equation (10) into consideration. Given that P represents the number of diagonals, P may be assumed to be much less than the dimensions of the matrix N. Further, since A is symmetric, P can only be odd, and Q=(P−1)/2 may represent the diagonal number in one side without the main diagonal. Thus, the parameter generator 222 may use the following equations:

$$\begin{matrix}{L}_{i , i} = \sqrt{{A}_{i \cdot i} - {\sum }_{i - Q}^{i - 1} {L}_{i , k}^{2}} & ( 16 ) \\ {L}_{i , j} = \frac{1}{{L}_{j , j}} ( {A}_{i , j} - {\sum }_{k = j - Q}^{j - 1} {L}_{i , k} {L}_{j , k} ) & ( 17 )\end{matrix}$$

Accordingly, the parameter generator 222 may use NQ divisions, N(Q²+Q)/2 multiplications, and N(Q²+Q)/2 subtractions, and N square root for solving Ly=b for y. Subsequently, the parameter generator 222 may use 2N division, 2NQ multiplications, and 2NQ subtractions for solving L^{T}x=y for x. Thus, the parameter generator 222 may solve a total of N(Q+2) divisions, N(Q²+5Q)/2 multiplications, N(Q²+5Q)/2 subtractions, and N square roots to obtain the stochastic trajectory 224, in which Q=1.

### Use of No-Square Root Version of Cholesky Decomposition

In some embodiments, the parameter generator 222 may derive the stochastic trajectory 224 by avoiding the use of square roots in the Cholesky decomposition. The performance of square roots via a processor (e.g., the one or more processor 202), generally takes longer than the performance of other calculations. Therefore, the avoidance of square root calculations by the parameter generator 222 may reduce the amount of latency during the derivation of the stochastic trajectory 224. In other words, the derivation of the stochastic trajectory 224 may be optimized.

The no-square root version of the Cholesky decomposition may be expressed as follows:

$$\begin{matrix}\begin{matrix}A = {LDL}^{T} \\ = ( \begin{matrix}1 & 0 & 0 \\ {L}_{21} & 1 & 0 \\ {L}_{31} & {L}_{32} & 1\end{matrix} ) ( \begin{matrix}{D}_{1} & 0 & 0 \\ 0 & {D}_{2} & 0 \\ 0 & 0 & {D}_{3}\end{matrix} ) ( \begin{matrix}1 & {L}_{21} & {L}_{31} \\ 0 & 1 & {L}_{32} \\ 0 & 0 & 1\end{matrix} ) \\ = ( \begin{matrix}{D}_{1} & & ( symmetrical ) \\ {L}_{21} {D}_{1} & {L}_{21}^{2} {D}_{1} + {D}_{2} & \\ {L}_{31} {D}_{1} {L}_{31} & {L}_{31} {L}_{21} {D}_{1} + {L}_{32} {D}_{2} & {L}_{31}^{2} {D}_{1} + {L}_{32}^{2} {D}_{2} + {L}_{33}^{2} {D}_{3}\end{matrix} )\end{matrix} & ( 18 ) \\ {L}_{i , j} = \frac{1}{{D}_{j}} ( {A}_{i , j} - {\sum }_{k = 1}^{j - 1} {L}_{ik} {L}_{jk} {D}_{k} ) , for i > j & ( 19 ) \\ {D}_{i} = {A}_{i , i} - {\sum }_{k = 1}^{i - 1} {L}_{ik}^{2} {D}_{k} & ( 20 )\end{matrix}$$

Moreover, the parameter generator 222 may also take the band matrix of equation (10) into consideration by using the following equations:

$$\begin{matrix}{L}_{i , j} = \frac{1}{{D}_{j}} ( {A}_{i \cdot i} - {\sum }_{j - Q}^{j - 1} {L}_{i , k} {L}_{j , k} {D}_{k} ) & ( 21 ) \\ {D}_{i} = {A}_{i , i} - {\sum }_{k = i - Q}^{i - 1} {L}_{i , k}^{2} {D}_{k} & ( 22 )\end{matrix}$$

Thus, in order to solve the equation (10), the parameter generator 222 may derive the solution in three logical steps. Initially, the parameter generator 222 may solve equation (10) for Lz=b for z. The parameter generator 222 may then solve equation (10) for Dy=z for y. Subsequently, the parameter generator 222 may solve equation (10) for L^{T}x=y for x.

Accordingly, the parameter generator 222 may solve a total of (Q+1) divisions, N(Q²+3Q) multiplications, and N(Q²+3Q) subtractions to obtain the stochastic trajectory 224, in which Q=1. The optimization of calculations via the use of the no-square root version of the Cholesky decomposition rather than the square root version of the Cholesky decomposition may be illustrated below in Table I. Table I illustrates the number of each type of calculation performed for each version of the Cholesky decomposition. As described above, the avoidance of division calculations may reduce the amount of latency during the derivation of the stochastic trajectory 224.

TABLE I
Comparison of Square Root and No-square Root Cholesky
Decompositions

| Q = 1 | multiplications | subtractions | division | SQRT |
|---|---|---|---|---|
| W/ SQRT | 3N | 3N | 3N | N |
| w/o SQRT | 4N | 4N | 2N | 0 |

### Use of One-Division Optimization

In additional embodiments, the parameter generator 222 may be further optimized to use a “one-division” optimization. The performance of division calculation via a processor (e.g., one or more processor 202), generally takes longer than the performance of multiplication and subtraction calculations. Therefore, the reduction of division calculations by the parameter generator 222 may reduce the amount of latency during the derivation of the stochastic trajectory 224. As a result, the derivation of the stochastic trajectory 224 may be further optimized.

In order to implement the “one-division” optimization, the parameter generator 222 may decompose A into the following equations:

$$\begin{matrix}\begin{matrix}A = {LD}^{- 1} {L}^{T} \\ = ( \begin{matrix}1 & 0 & 0 \\ {L}_{21} & 1 & 0 \\ 0 & {L}_{32} & 1\end{matrix} ) ( \begin{matrix}1 / {D}_{1}^{- 1} & 0 & 0 \\ 0 & 1 / {D}_{2}^{- 1} & 0 \\ 0 & 0 & 1 / {D}_{3}^{- 1}\end{matrix} ) ( \begin{matrix}1 & {L}_{21} & 0 \\ 0 & 1 & {L}_{32} \\ 0 & 0 & 1\end{matrix} )\end{matrix} & ( 23 ) \\ {L}_{ij} = {D}_{j}^{- 1} {A}_{ij} & ( 24 ) \\ {D}_{i}^{- 1} = {A}_{i , i} - {L}_{i , i - 2}^{2} / {D}_{i - 2}^{- 1} & ( 25 )\end{matrix}$$

Accordingly, by further decomposing A, the parameter generator 222 may derive the stochastic trajectory 224 via the no-square root version of the Cholesky decomposition that includes a single division calculation. Table II illustrates the number of operations for two versions of the no-square root Cholesky decomposition. The first version is the original no-square root Cholesky decomposition, and the second version is the “one-division” no-square root Cholesky decomposition.

TABLE II
Comparison of No-square Root Cholesky Decomposition

| Q = 1 | multiplications | subtractions | division | SQRT |
|---|---|---|---|---|
| One-division version | 6N | 6N | N | 0 |
| Original version | 4N | 4N | 2N | 0 |

### Saw-Tooth Trajectory Smoothing

The generation of the stochastic trajectory 224 based on the static feature parameters 110a and delta feature parameters 110b may produce a saw-tooth trajectory. The saw-tooth trajectory may be due to the specific band-diagonal structure of the matrix in the weighted least square synthesis equations. For example, referring back to equations (11) and (12), since the odd numbered components [c₁,c₃,c₅] and even numbered components [c₂,c₄] are solved independently, there may be no constraint between adjacent frames to insure smoothness. As a result, the parameter generator 222 may generate a stochastic trajectory that has saw-tooth trajectory fluctuations. The saw-tooth fluctuations may cause subjective perceptible distortions in the synthesized speech 108, so that the speech may sound “sandy” or “coarse”.

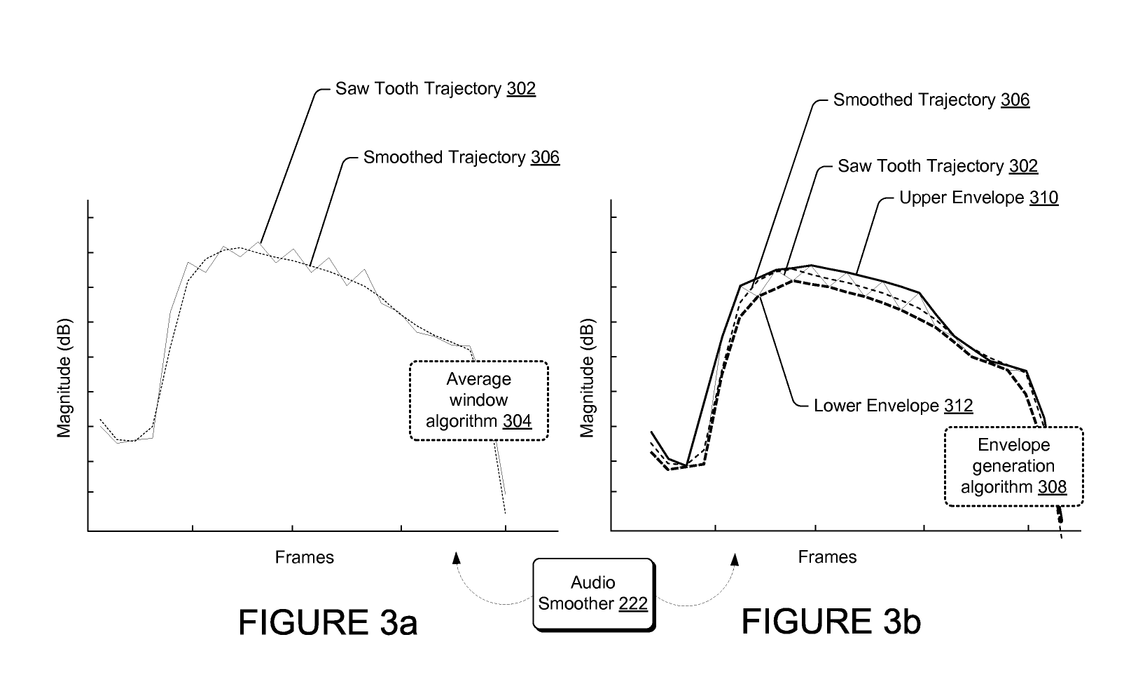

Thus, the audio smoother 226 may eliminate the saw-tooth distortions in the stochastic trajectory 224 generated by the parameter generator 222. The smoothing of the saw-tooth distortions by the audio smoother 226 is illustrated in FIG. 3.

FIGS. 3a and 3b are example graphs that illustrate the post generation smoothing of audio trajectories, in accordance with various embodiments. As shown in FIG. 3a, the parameter generator 222 may produce a log-gain stochastic trajectory 302. Accordingly, the audio smoother 226 may use an average window algorithm 304 (e.g., boxcar smoothing) to generate a smoothed trajectory 306. As shown in FIG. 3a, the smoothed trajectory 306 does not exhibit the saw-tooth fluctuations that produce “sandy” or “coarse” speech.

FIG. 3b illustrates another exemplary technique for eliminating the saw-tooth effect from the log-gain stochastic trajectory 302. The technique includes the use of an envelope generation algorithm 308 to generate at least one of an upper envelope 310 or a lower envelope 312 for the saw-tooth trajectory 302. As shown in FIG. 3b, each of the upper envelope 310 and the lower envelope 312 may exhibit greater distortion from the saw-tooth trajectory 302 than the smooth trajectory 306. However, each of the upper envelope 310 and the lower envelope 312 may nevertheless be used as the smoothed versions of the saw-tooth trajectory 302.

Returning to FIG. 2, it will be appreciated that while some of the trajectory smooth techniques are discussed in FIG. 3, other techniques may be used by the audio smoother 226 to smooth the stochastic trajectory generated by the parameter generator 222.

### Speech Synthesis Using the Derived Stochastic Trajectory

In various embodiments, referring to FIG. 2, the mixed excitation generator 230 may receive speech patterns 228 (e.g., fundamental frequency patterns “F0”) that are encompassed in the stochastic trajectory generated by the parameter generator 222. In turn, the mixed excitation generator 230 may produce excitations 232. The excitations 232 may be passed to the Linear Predicative Coding (LPC) synthesizer 234.

Likewise, the parameter generator 222 may further provide Line Spectral Pair (LSP) coefficients 236 and gain 238, as encompassed in the generated stochastic trajectory to the LPC synthesizer 234. The LPC synthesizer 234 may synthesize the excitations 232, the LSP coefficients 236 and the gain 238 into synthesized speech 108.

The user interface module 206 may interact with a user via a user interface (not shown). The user interface may include a data output device (e.g., visual display, audio speakers), and one or more data input devices. The data input devices may include, but are not limited to, combinations of one or more of keypads, keyboards, mouse devices, touch screens, microphones, speech recognition packages, and any other suitable devices or other electronic/software selection methods. The user interface module 206 may enable a user to input or select the input text 106 for conversion into synthesized speech 108. Moreover, the user interface module 206 may provide the synthesized speech 108 from the LPC synthesizer 234 to the audio speakers for acoustic output.

The application module 208 may include one or more applications that utilize the text-to-speech engine 102. For example, but not as a limitation, the one or more application may include a global positioning system (GPS) navigation application, a dictionary application, a text messaging application, a word processing application, and the like. Accordingly, in various embodiments, the text-to-speech engine 102 may include one or more interfaces, such as one or more application program interfaces (APIs), which enable the application module 208 to provide input text 106 to the text-to-speech engine 102.

The input/output module 210 may enable the text-to-speech engine 102 to receive input text 106 from another device. For example, the text-to-speech engine 102 may receive input text 106 from at least one of another electronic device, (e.g., a server) via one or more networks.

As described above, the data storage module 212 may store the stream-dependent Hidden Markov Models (HMMs) 214. The data storage module 212 may further store one or more input texts 106, as well as one or more synthesized speech 108. The one or more input texts 106 may be in various forms, such as documents in various formats, downloaded web pages, and the like. The data storage module 212 may also store any additional data used by the text-to-speech engine 102, such as, but not limited to, the speech patterns 228, PSP coefficients 236, and gain 238.

The data storage module 212 may further store various setting regarding calculation preferences (e.g., square root vs. no-square root version of the Cholesky decomposition, the use of the “one-division” optimization, etc.). In various embodiments, the calculation preference settings may be predetermined based on the type and capabilities of the one or more processors 202 installed in the electronic device 104.

### Example Processes

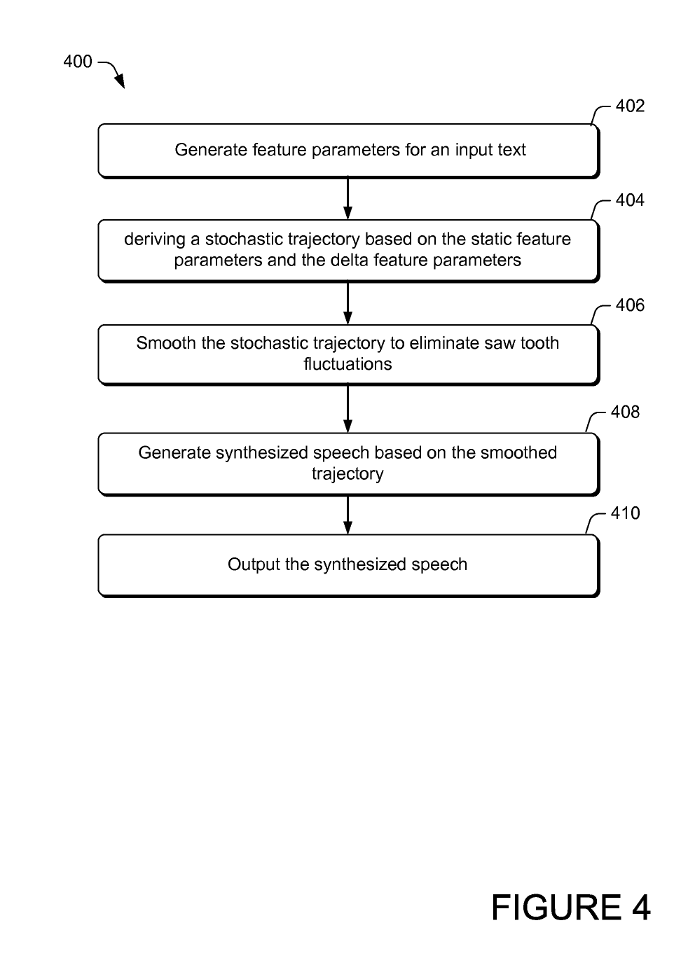

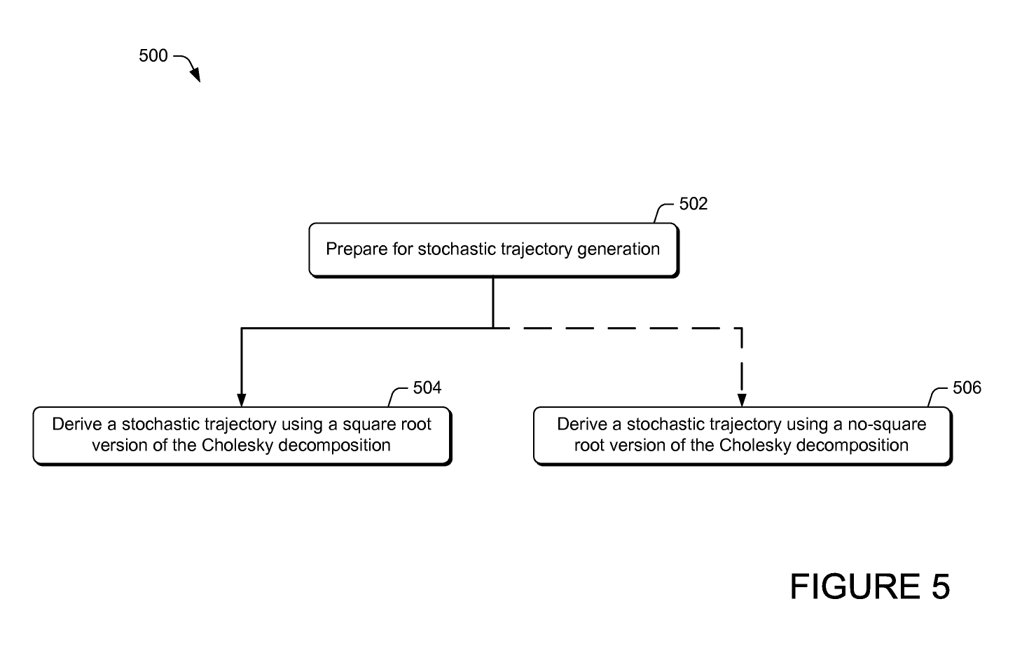

FIGS. 4-5 describe various example processes for implementing the small footprint text-to-speech engine 102. The order in which the operations are described in each example process is not intended to be construed as a limitation, and any number of the described blocks can be combined in any order and/or in parallel to implement each process. Moreover, the blocks in the FIGS. 4-5 may be operations that can be implemented in hardware, software, and a combination thereof. In the context of software, the blocks represent computer-executable instructions that, when executed by one or more processors, cause one or more processors to perform the recited operations. Generally, computer-executable instructions include routines, programs, objects, components, data structures, and the like that cause the particular functions to be performed or particular abstract data types to be implemented.

FIG. 4 is a flow diagram that illustrates an example process 400 to generate synthesized speech from input text via the small footprint text-to-speech engine 102, in accordance with various embodiments.

At block 402, the text-to-speech engine 102 may receive an input text 106 and use the parameter generator 222 to generate feature parameters 110. The generated feature parameters 110 may include the static feature parameters 110a and the delta feature parameters 110b. In various embodiments, the parameter generator 222 may generate the static feature parameters 110 from the context dependent phoneme labels 220.

At block 404, the parameter generator 222 may derive a stochastic trajectory (e.g., saw-tooth trajectory 302) based on the static feature parameters 110a and the feature parameters 110b.

At block 406, the parameter generator 222 may smooth the generated stochastic trajectory to remove saw-tooth fluctuations. In various embodiments, the parameter generator 222 may use an average window algorithm, an envelope generation algorithm, or other comparable smoothing algorithms to generate a smoothed trajectory based on the generated stochastic trajectory.

At block 408, the text-to-speech engine 102 may generate synthesized speech based on the smoothed trajectory. In various embodiments, the speech patterns 228, LSP coefficients 236, and gain 238 encompassed by the stochastic trajectory (e.g., saw-tooth trajectory 302) may be processed by the various components of the text-to-speech engine 102 into synthesized speech 108.

At block 410, the text-to-speech engine 102 may output the synthesized speech 108. In various embodiments, the electronic device 104 on which the text-to-speech engine 102 resides may use speakers to transmit the synthesized speech 108 as acoustic energy to be heard by a user. The electronic device 104 may also store the synthesized speech 108 as data in the data storage module 212 for subsequent retrieval and/or output.

FIG. 5 is a flow diagram that illustrates an example process 500 to optimize the generation of a representative stochastic trajectory using the small footprint text-to-speech engine, in accordance with various embodiments. The example process 500 may further illustrate steps performed during the generation of the representation trajectory in block 404 of the example process 400.

At block 502, the parameter generator 502 may prepare for the generation of the stochastic trajectory based on the static feature parameters 110a and the delta feature parameters 110b. In various embodiments, the preparation may include inputting the static feature parameters 110a and the delta feature parameters 110b into a plurality of equations that may be solved via the Cholesky decomposition. The process may then proceed to block 504 in some embodiments.

At block 504, the parameter generator 222 may use a square root version of the Cholesky decomposition to derive a stochastic trajectory (e.g., saw-tooth trajectory 302) based on the static feature parameters 110a and the delta feature parameters 110b.

However, in alternative embodiments, the process 500 may proceed to block 506 instead of block 504. At block 506, the parameter generator 222 may use the square root version of the Cholesky decomposition to derive the stochastic trajectory based on the static feature parameters 110a and the delta feature parameters 110b. In various embodiments, the use the square root version or the no-square root version of the Cholesky decomposition by the parameter generator 200 may be based on predetermined application settings stored in the data storage module 212, hardware configuration, and/or the like.

In some alternative embodiments, the parameter generator 222 may further use the “one-division” optimization in conjunction with the no-square root version of the Cholesky decomposition in block 506. In such alternative embodiments, the parameter generator 222 may or may not use the “one-division” optimization in conjunction with the no-square root version of the Cholesky decomposition based on predetermined application settings stored in the data storage module 212, hardware configuration, and/or the like.

### Example Computing Device

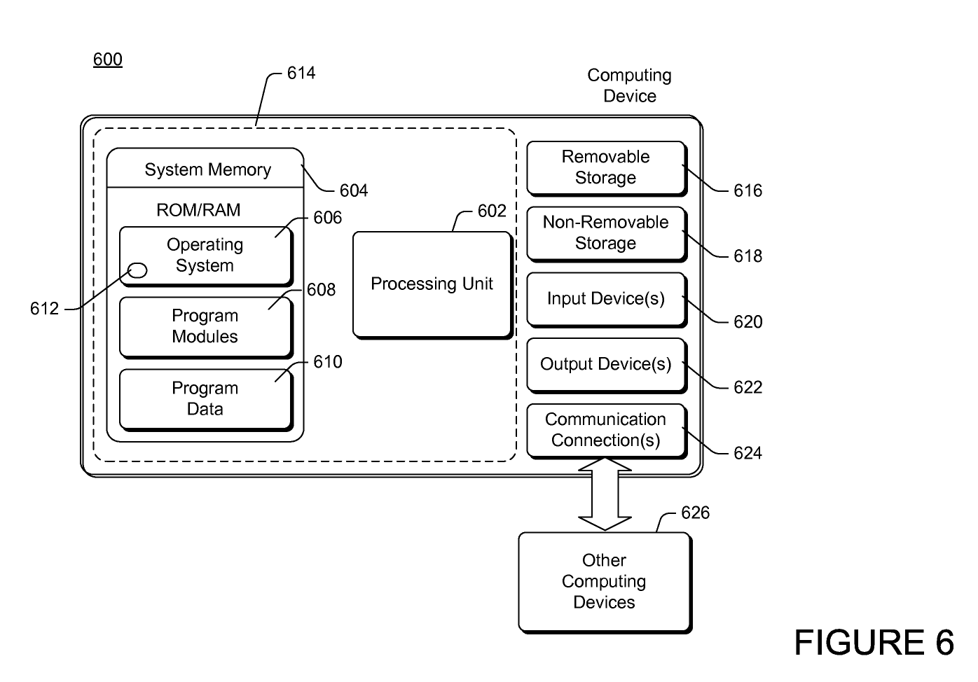

FIG. 6 illustrates a representative computing device 600 that may be used to implement the small footprint text-to-speech engine, such as the text-to-speech engine 102. However, it will readily appreciate that the techniques and mechanisms may be implemented in other computing devices, systems, and environments. The computing device 600 shown in FIG. 6 is only one example of a computing device and is not intended to suggest any limitation as to the scope of use or functionality of the computer and network architectures. Neither should the computing device 600 be interpreted as having any dependency or requirement relating to any one or combination of components illustrated in the example computing device.

In at least one configuration, computing device 600 typically includes at least one processing unit 602 and system memory 604. Depending on the exact configuration and type of computing device, system memory 604 may be volatile (such as RAM), non-volatile (such as ROM, flash memory, etc.) or some combination thereof. System memory 604 may include an operating system 606, one or more program modules 608, and may include program data 610. The operating system 606 includes a component-based framework 612 that supports components (including properties and events), objects, inheritance, polymorphism, reflection, and provides an object-oriented component-based application programming interface (API), such as, but by no means limited to, that of the .NET™ Framework manufactured by the Microsoft® Corporation, Redmond, Wash. The computing device 600 is of a very basic configuration demarcated by a dashed line 614. Again, a terminal may have fewer components but may interact with a computing device that may have such a basic configuration.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by removable storage 616 and non-removable storage 618. Computer storage media may include volatile and nonvolatile, removable and non-removable media implemented in any method or technology for storage of information, such as computer readable instructions, data structures, program modules, or other data. System memory 604, removable storage 616 and non-removable storage 618 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by Computing device 600. Any such computer storage media may be part of device 600. Computing device 600 may also have input device(s) 620 such as keyboard, mouse, pen, voice input device, touch input device, etc. Output device(s) 622 such as a display, speakers, printer, etc. may also be included.

Computing device 600 may also contain communication connections 624 that allow the device to communicate with other computing devices 626, such as over a network. These networks may include wired networks as well as wireless networks. Communication connections 624 are some examples of communication media. Communication media may typically be embodied by computer readable instructions, data structures, program modules, etc.

It is appreciated that the illustrated computing device 600 is only one example of a suitable device and is not intended to suggest any limitation as to the scope of use or functionality of the various embodiments described. Other well-known computing devices, systems, environments and/or configurations that may be suitable for use with the embodiments include, but are not limited to personal computers, server computers, hand-held or laptop devices, multiprocessor systems, microprocessor-base systems, set top boxes, game consoles, programmable consumer electronics, network PCs, minicomputers, mainframe computers, distributed computing environments that include any of the above systems or devices, and/or the like.

The Hidden Markov Model (HMM)-based text-to-speech engine, as described herein, has a small footprint and exhibits small latency when compared to traditional text-to-speech engines. Thus, the small footprint text-to-speech engine may be especially suitable for use in an embedded system that has limited memory and processing capability. The small footprint text-to-speech engine may provide greater features and better user experience in comparison to other text-to-speech engines. As a result, user satisfaction with the embedded that presents information via synthesized speech may be maximized at a minimal cost.

### Conclusion

In closing, although the various embodiments have been described in language specific to structural features and/or methodological acts, it is to be understood that the subject matter defined in the appended representations is not necessarily limited to the specific features or acts described. Rather, the specific features and acts are disclosed as exemplary forms of implementing the claimed subject matter.

1. A computer readable medium storing computer-executable instructions that, when executed, cause one or more processors to perform acts comprising:
generating a set of feature parameters for an input text, the set of feature parameters including static feature parameters and delta feature parameters;
deriving a saw-tooth stochastic trajectory that represents the speech characteristics of the input text based on the static feature parameters and the delta feature parameters;
producing a smoothed trajectory from the saw-tooth stochastic trajectory; and
generating synthesized speech based on the smoothed trajectory.

2. The computer readable medium of claim 1, further storing an instruction that, when executed, cause the one or more processors to perform an act comprising outputting the synthesized speech to at least one of an acoustic speaker or a data storage.

3. The computer readable medium of claim 1, wherein the generating includes using trained stream-dependent Hidden Markov Models (HMMs) to generate the set of feature parameters.

4. The computer readable medium of claim 1, wherein the deriving includes inputting the static feature parameters and the delta feature parameters into equations that are solved via Cholesky decomposition.

5. The computer readable medium of claim 1, wherein the deriving includes using at least a square root version of Cholesky decomposition or a no-square root version of Cholesky decomposition to derive the saw-tooth stochastic trajectory.

6. The computer readable medium of claim 1, wherein the deriving includes using at least a no-square root version of Cholesky decomposition that includes a one-division optimization to derive the saw-tooth stochastic trajectory.

7. The computer readable medium of claim 1, wherein the producing includes using an average window algorithm or an envelope generation algorithm to smooth the saw-tooth stochastic trajectory.

8. The computer-readable medium of claim 1, wherein the smoothed trajectory encompasses speech patterns, line spectral pair (LSP) coefficients, fundamental frequency, and a gain, and wherein the producing includes producing the synthesized speech based on the speech patterns, the line spectral pair (LSP) coefficients, the fundamental frequency, and the gain.

9. A computer implemented method, comprising:
under control of one or more computing systems configured with executable instructions,
generating a set of feature parameters for an input text using trained stream-dependent Hidden Markov Models (HMMs), the set of feature parameters including static feature parameters and delta feature parameters;
deriving a saw-tooth stochastic trajectory that represents the speech characteristics of the input text based on the static feature parameters and the delta feature parameters.

10. The computer implemented method of claim 9, further comprising producing a smoothed trajectory from the saw-tooth stochastic trajectory.

11. The computer implemented method of claim 9, wherein deriving includes inputting the static feature parameters and the delta feature parameters into equations that are solved via Cholesky decomposition.

12. The computer implemented method of claim 9, wherein the deriving includes using a no-square root version of Cholesky decomposition to eliminate square root calculations during the derivation of the saw-tooth stochastic trajectory.

13. The computer implemented method of claim 9, wherein the deriving includes using a no-square root version of Cholesky decomposition and a one-division optimization to eliminate square root and division calculations during the derivation of the saw-tooth stochastic trajectory.

14. The computer implemented method of claim 9, wherein the smoothed trajectory encompasses speech patterns, line spectral pair (LSP) coefficients, a fundamental frequency, and a gain, and wherein the producing includes producing the synthesized speech based on the speech patterns, the line spectral pair (LSP) coefficients, the fundamental frequency, and the gain.

15. The computer implemented method of claim 10, wherein the producing includes using an average window algorithm or an envelope generation algorithm to smooth the saw-tooth stochastic trajectory.

16. A system, comprising:
one or more processors;
a memory that includes a plurality of computer-executable components, the plurality of computer-executable components comprising:
a parameter generator to generate a set of feature parameters for an input text, the set of feature parameters including static feature parameters and delta feature parameters, and to derive a saw-tooth stochastic trajectory based on the static feature parameters and the delta feature parameters; and
an audio smoother to producing a smoothed trajectory from the saw-tooth stochastic trajectory.

17. The system of claim 16, further comprising a linear predicative coding (LPC) synthesizer to generate synthesized speech based on the smoothed trajectory.

18. The system of claim 16, wherein the parameter generator is to use at least a square root version of Cholesky decomposition or a no-square root version of the Cholesky decomposition to derive the saw-tooth stochastic trajectory.

19. The system of claim 16, wherein the parameter generator is to use at least a no-square root version of Cholesky decomposition that includes a one-division optimization to derive the saw-tooth stochastic trajectory.

20. The system of claim 19, wherein the audio smoother is to use an average window algorithm or an envelope generation algorithm to smooth the saw-tooth stochastic trajectory.
